(19) United States
(12) Patent Application Publication
(10) Pub. No.: US 2006/0001609 A1
(43) Pub. Date: Jan. 5, 2006

(54) Plasma display apparatus and driving method thereof

(75) Inventor: Seong Hak Moon, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/172,795

(22) Filed: Jul. 5, 2005

(30) Foreign Application Priority Data
Jul. 2, 2004 (KR) 10-2004-0051745

(51) Int. Cl. G09G 3/28

(52) U.S. Cl. 345/67

(57) ABSTRACT

The present invention relates to a plasma display apparatus, and more particularly, to a plasma display apparatus and driving method thereof, wherein a sustain waveform of a positive polarity and a sustain waveform of a negative polarity are applied upon driving of the apparatus. According to the present invention, the plasma display apparatus includes a plasma display panel in which a plurality of sustain electrodes having scan electrodes and common electrodes is formed, a driving unit for driving the plurality of the sustain electrodes, and a driving pulse controller for controlling the driving unit to apply a scan waveform of a negative polarity to the scan electrodes during an address period, and a sustain waveform of a positive polarity and a sustain waveform of a negative polarity, which has the same voltage as that of the scan waveform, to the scan electrodes during a sustain period, and to apply sustain waveforms having an opposite polarity to the sustain waveform of the positive polarity and the sustain waveform of the negative polarity, which are applied to the scan electrodes, to the common electrodes during the sustain period. As such, since a low voltage is used, power consumption can be saved, efficiency can be increased, and the load of a high voltage to a driving circuit can be curtained.

### BACKGROUND OF THE INVENTION

### CROSS-REFERENCE TO RELATED APPLICATIONS

This nonprovisional application claims priority under 35 U.S.C. § 119 on Patent Application No. 10-2004-0051745 filed in Republic of Korea on Jul. 2, 2004, the entire contents of which are hereby incorporated by reference.

1. Field of the Invention

The present invention relates to a plasma display apparatus, and more particularly, to a plasma display apparatus and driving method thereof, wherein a sustain waveform of a positive polarity and a sustain waveform of a negative polarity are applied upon driving of the apparatus.

2. Background of the Related Art

Generally, a plasma display apparatus includes a plasma display panel in which a barrier rib formed between a front substrate and a rear substrate forms one unit cell. Each cell is filled with a main discharge gas such as neon (Ne), helium (He) or a mixed gas (Ne+He) of Ne and He, and an inert gas containing a small amount of xenon. If the inert gas is discharged with a high frequency voltage, vacuum ultraviolet rays are generated. Phosphors formed between the barrier ribs are light-emitted to display an image. Such a plasma display panel can be made thin and slim, and has thus been in the spotlight as the next-generation display devices.

FIG. 1 is a perspective view illustrating the structure of a common plasma display panel.

As shown in FIG. 1, the plasma display panel includes a front substrate 100 in which a plurality of sustain electrode pairs which have plural pairs of scan electrodes 102 and common electrodes 103, are arranged on front glass 101 serving as the display surface on which the images are displayed, and a rear substrate 110 in which a plurality of address electrodes 113 disposed to cross the plurality of the sustain electrode pairs is arranged on rear glass 111 serving as the rear surface. At this time, the front substrate 100 and the rear substrate 110 are parallel to each other with a predetermined distance therebetween.

The front substrate 100 includes the scan electrodes 102 and the common electrodes 103, which perform discharge against the other in a mutual manner and maintain emission of a cell, in one discharge cell. That is, each of the scan electrode 102 and the common electrode 103 has a transparent electrode “a” made of a transparent ITO material, and a bus electrode “b” made of a metal material. The scan electrodes 102 and the common electrodes 103 are covered with one or more dielectric layers 104 for limiting a discharge current and providing insulation among the electrode pairs. A protection layer 105 on which magnesium oxide (MgO) is deposited in order to facilitate a discharge condition is formed on the entire surface of the dielectric layer 104.

Barrier ribs 112 of a stripe type (or a well type), for forming a plurality of discharge spaces, i.e., discharge cells, are arranged parallel to each other in the rear substrate 110. Further, a plurality of address electrodes 113, which performs an address discharge, is disposed parallel to the barrier ribs 112. R, G and B phosphors 114 that emit visible ray for image display upon address discharge are coated on a top surface of the rear substrate 110. A dielectric layer 115 for protecting the address electrodes 113 is formed between the address electrodes 113 and the phosphors 114.

FIG. 2 is a view for explaining a method of implementing an image of a conventional plasma display apparatus.

As shown in FIG. 2, one frame period is divided into a plurality of sub-fields having a different number of emission. The plasma display panel is light-emitted in a sub-field period corresponding to a gray level value of an input image signal, thereby implementing an image.

Each of the sub-fields is subdivided into a reset period for uniformly generating discharge, an address period for selecting cells to be discharged, and a sustain period for implementing the gray levels according to the number of discharge. For example, if it is desired to display an image with 256 gray levels, a frame period (16.67 ms) corresponding to 1/60 seconds is divided into eight sub-fields.

Further, each of the eight sub-fields is subdivided into a reset period, an address period and a sustain period. In this case, the sustain period increases in the ratio of 2ⁿ (where, n=0,1,2,3,4,5,6,7) in each sub-field. As such, since the sustain period varies in each sub-field, the gray level of an image can be implemented. The plasma display apparatus constructed above will be described below with reference to FIG. 3.

FIG. 3 is a schematic block diagram of a conventional plasma display apparatus.

As shown in FIG. 3, the conventional plasma display apparatus includes a plasma display panel 300, a signal processor 310, a data alignment unit 320, a data driver 330, a scan driver 340, a sustain driver 350 and a driving pulse controller 360.

On the plasma display panel 300 are formed scan electrodes Y₁ to Yn and a sustain electrode Z, and a plurality of address electrodes X₁ to Xm crossing the scan electrodes Y₁ to Yn and the sustain electrode Z.

The signal processor 310 converts an externally input image signal into an image signal for driving the plasma display apparatus. This image signal processor 310 includes an inverse gamma correction unit for performing an inverse gamma correction process on an image signal, a gain controller for controlling a gain value of an image signal, a halftone unit for improving gray level representation power, and a mapping unit (not shown) for mapping image signals on a sub-field basis.

The data alignment unit 320 realigns the image signals that are mapped in the signal processor 310 on a sub-field basis.

The data driver 330 applies an address pulse to the address electrodes X₁ to Xm formed in the plasma display panel 300 during an address period corresponding to the aligned image signal.

The scan driver 340 drives the scan electrodes Y₁ to Yn formed in the plasma display panel 300. The scan driver 340 applies a set-up pulse and a set-down pulse during the reset period, sequentially applies scan pulses during the address period, and applies a sustain pulse during the sustain period.

The sustain driver 350 drives the sustain electrode Z, which is formed in the plasma display panel 300 and serves as a common electrode. The sustain driver 350 applies a bias pulse of a positive polarity during the address period, and alternately applies at least one or more sustain pulses for a sustain discharge during the sustain period alternately with the scan sustain pulse.

The driving pulse controller 360 controls timings of the respective driving pulses applied to the data driver 330, the scan driver 340 and the sustain driver 350 during the reset period, the address period or the sustain period. Furthermore, the driving pulse controller 360 controls the image signals, which are realigned in the data alignment unit 320, to be sequentially read and then supplied to the data driver 330 for one scan line according to an externally input image signal.

FIG. 4 is a circuit diagram showing a conventional plasma display apparatus.

Referring to FIG. 4, each of electrodes of a plasma display panel 400 is connected to a scan driver 410 and a sustain driver 420.

If a channel corresponding to a first scan electrode Y1 is selected during the address period, channels corresponding to the remaining scan electrodes Y2, Y3 . . . , Yn are not selected. If the channel is selected as such, a second switching element 413-1 of a first scan driver 410-1 corresponding to the selected channel is turned on, and a scan switching element 414 is turned on. At the same time, first switching elements 411-2 to 411-n of the scan drivers 410-2 to 410-n corresponding to the non-selected channels and a ground switching element 415 are turned on.

Accordingly, to the selected first scan electrode Y1 is applied a scan voltage −Vyscan, and the remaining scan electrodes Y2 to Yn become a ground level. In this state, if an address pulse is applied to the address electrodes X1 to Xm, a write operation is performed on a cell location in a first line.

The address pulse becomes grounded through the first switching elements 411-2 to 411-n of the scan drivers 410-2 to 410-n corresponding to the remaining scan electrodes Y2 to Yn and the ground switching element 415.

If the scan process is performed on the entire scan electrodes, a sustain process for maintaining discharging of selected cells is performed.

A first sustain switching element 416, second switching elements 413-1 to 413-n and a ground switching element 422 are turned on, and a scan switching element 414, first switching elements 411-1 to 411-n, a ground switching element 415 and a second sustain switching element 421 are turned off. Accordingly, a sustain voltage +Vsy is applied to all the scan electrodes Y1 to Yn, and all the sustain electrodes Z1 to Zn become a ground level.

After the sustain voltage is applied to all the scan electrodes Y1 to Yn, a second sustain switching element 421, the first switching elements 411-1 to 411-n and the ground switching element 415 are turned on, and the scan switching element 414, the first sustain switching element 416 and the second switching elements 413-1 to 413-n are turned off. Accordingly, a sustain voltage +Vsz is applied to all the sustain electrodes, and all the scan electrodes Y1 to Yn become a ground level.

In the conventional plasma display apparatus constructed above, the scan driver 410 and the sustain driver 420 apply the sustain voltages +Vsy, +Vsz of a high voltage to the scan electrodes and the sustain electrode.

As such, if the sustain voltages +Vsy, +Vsz of a high voltage are applied from the scan driver 410 and the sustain driver 420, power consumption increases and efficiency relatively decreases as invalid power rises. Furthermore, there is a problem in that the scan driver 410 and the sustain driver 420 are overloaded since the sustain voltages +Vsy, +Vsz of a high voltage are used.

### SUMMARY OF THE INVENTION

Accordingly, the present invention has been made in view of the above problems, and it is an object of the present invention to provide a plasma display apparatus in which power consumption can be reduced through an improved plasma display apparatus and driving method thereof.

Another object of the present invention is to provide a plasma display apparatus in which driving efficiency can be increased through an improved plasma display apparatus and driving method thereof.

Still another object of the present invention is to provide a plasma display apparatus in which the load of a high voltage to a driving circuit can be reduced through an improved plasma display apparatus and driving method thereof.

Further another object of the present invention is to provide a plasma display apparatus in which the unit cost can be saved through an improved plasma display apparatus and driving method thereof.

To achieve the above objects, according to a first embodiment of the present invention, there is provided a plasma display apparatus, including a plasma display panel in which a plurality of sustain electrodes having scan electrodes and common electrodes is formed, a driving unit for driving the plurality of the sustain electrodes, and a driving pulse controller for controlling the driving unit to apply a scan waveform of a negative polarity to the scan electrodes during an address period, and a sustain waveform of a positive polarity and a sustain waveform of a negative polarity, which has the same voltage as that of the scan waveform, to the scan electrodes during a sustain period, and to apply sustain waveforms having an opposite polarity to the sustain waveform of the positive polarity and the sustain waveform of the negative polarity, which are applied to the scan electrodes, to the common electrodes during the sustain period.

According to the present invention, the driving unit for driving the sustain electrodes includes a scan driver including a first switching element and a second switching element for supplying the waveforms to the scan electrodes, and a common driver including a first switching element and a second switching element for supplying the waveforms to the common electrodes.

According to the present invention, the scan driver applies a scan reference waveform and the sustain waveform of the positive polarity through the first switching element, and the scan waveform and the sustain waveform of the negative polarity through the second switching element.

The scan reference waveform according to the present invention is a ground voltage level.

The common driver according to the present invention applies the sustain waveform of the positive polarity through the first switching element, and the sustain waveform of the negative polarity through the second switching element.

According to a second embodiment of the present invention, there is provided a plasma display apparatus, including a plasma display panel in which a plurality of sustain electrodes having scan electrodes and common electrodes is formed, a driving unit for driving the plurality of the sustain electrodes, and a driving pulse controller for controlling the driving unit to apply a set-up waveform to the scan electrodes during a set-up period, a set-down waveform having an opposite polarity to the set-up waveform to the scan electrodes during a set-down period, and a sustain waveform of a positive polarity and a sustain waveform of a negative polarity to the scan electrodes during a sustain period, and to apply a waveform having an opposite polarity to the set-up waveform to the common electrodes during a set-up period, a waveform having an opposite polarity to the set-down waveform to the sustain electrodes during a set-down period, and a sustain waveform having an opposite polarity to the sustain waveform of the positive polarity and the sustain waveform of the negative polarity, which are applied to the scan electrodes, to the sustain electrodes during a sustain period.

According to the present invention, the set-up waveform constitutes a ramp-up waveform that gradually rises, after a waveform of a positive polarity having the same voltage level as that of the sustain waveform of the positive polarity is applied, and the set-down waveform constitutes a ramp-down waveform that gradually falls.

According to the present invention, the waveform having the opposite polarity to the set-up waveform applied to the common electrodes has the same voltage level as that of the sustain waveform of the negative polarity, and the waveform having the opposite polarity to the set-down waveform applied to the sustain electrodes has the same voltage level as that of the sustain waveform of the positive polarity.

According to the present invention, the driving pulse controller controls the driving unit to apply a scan waveform of a negative polarity, which is the same as the sustain waveform of the negative polarity, to the scan electrodes during an address period.

According to the present invention, the driving unit includes a scan driver including a first switching element and a second switching element for supplying the waveforms to the scan electrodes, and a common driver including a first switching element and a second switching element for supplying the waveforms to the common electrodes.

According to the present invention, the scan driver applies the set-up waveform and the sustain waveform of the positive polarity through the first switching element, and the set-down waveform and the sustain waveform of the negative polarity through the second switching element.

According to the present invention, the common driver applies a waveform having an opposite polarity to the set-down waveform and the sustain waveform of the positive polarity through the first switching element, and a waveform having an opposite polarity to the set-up waveform and the sustain waveform of the negative polarity through the second switching element.

According to the present invention, a voltage difference between the sustain waveform of the positive polarity and the sustain waveform of the negative polarity becomes the amount of a sustain discharge voltage.

According to the present invention, the sustain waveform of the positive polarity and the sustain waveform of the negative polarity have the same voltage.

According to the present invention, the sustain waveform of the positive polarity and the sustain waveform of the negative polarity have different voltages.

According to the present invention, the sustain waveform of the negative polarity has a voltage higher than that of the sustain waveform of the positive polarity.

According to the present invention, the sustain waveform of the positive polarity has a voltage higher than that of the sustain waveform of the negative polarity.

According to the present invention, when the polarity of the sustain waveform applied to one or more of the scan electrodes or the common electrodes changes, a predetermined sustain reference waveform is applied.

According to the present invention, the sustain reference waveform is a ground voltage level.

According to the present invention, the plasma display apparatus further includes at least one or more ground switching elements for maintaining the ground voltage level.

According to a first embodiment of the present invention, there is provided a method of driving a plasma display apparatus in which a plurality of sustain electrodes having plural pairs of scan electrodes and common electrodes is formed, including the steps of applying a scan waveform of a negative polarity to the scan electrodes during an address period, and applying a sustain waveform of a positive polarity and a sustain waveform of a negative polarity, which has the same voltage as that of the scan waveform, to the scan electrodes during a sustain period, and applying sustain waveforms having an opposite polarity to the sustain waveform of the positive polarity and the sustain waveform of the negative polarity, which are applied to the scan electrodes, to the common electrodes during a sustain period.

According to the present invention, a scan reference waveform is applied to the scan electrodes during an address period.

According to the present invention, the scan reference waveform is a ground voltage level.

According to a second embodiment of the present invention, there is provided a method of driving a plasma display apparatus in which a plurality of sustain electrodes having plural pairs of scan electrodes and common electrodes is formed, including the steps of applying a set-up waveform to the scan electrodes during a set-up period, a set-down waveform having an opposite polarity to the set-up waveform to the scan electrodes during a set-down period, and a sustain waveform of a positive polarity and a sustain waveform of a negative polarity to the scan electrodes during a sustain period, and applying a waveform having an opposite polarity to the set-up waveform to the sustain electrodes during a set-up period, a waveform having an opposite polarity to the set-down waveform to the sustain electrodes during a set-down period, and a sustain waveform having an opposite polarity to the sustain waveform of the positive polarity and the sustain waveform of the negative polarity, which are applied to the scan electrodes, to the common electrodes during a sustain period.

According to the present invention, the set-up waveform constitutes a ramp-up waveform that gradually rises, after a waveform of a positive polarity having the same voltage level as that of the sustain waveform of the positive polarity is applied, and the set-down waveform constitutes a ramp-down waveform that gradually falls.

According to the present invention, the waveform having the opposite polarity to the set-up waveform applied to the common electrodes has the same voltage level as that of the sustain waveform of the negative polarity, and the waveform having the opposite polarity to the set-down waveform applied to the sustain electrodes has the same voltage level as that of the sustain waveform of the positive polarity.

According to the present invention, a scan waveform of a negative polarity, which is the same as the sustain waveform of the negative polarity, is applied to the scan electrodes during an address period.

According to the present invention, a voltage difference between the sustain waveform of the positive polarity and the sustain waveform of the negative polarity becomes the amount of a sustain discharge voltage.

According to the present invention, the sustain waveform of the positive polarity and the sustain waveform of the negative polarity have the same voltage.

According to the present invention, the sustain waveform of the positive polarity and the sustain waveform of the negative polarity have different voltages.

According to the present invention, the sustain waveform of the negative polarity has a voltage higher than that of the sustain waveform of the positive polarity.

According to the present invention, the sustain waveform of the positive polarity has a voltage higher than that of the sustain waveform of the negative polarity.

According to the present invention, when the polarity of the sustain waveform applied to one or more of the scan electrodes or the common electrodes changes, a predetermined sustain reference waveform is applied.

According to the present invention, the sustain reference waveform is a ground voltage level.

### BRIEF DESCRIPTION OF THE DRAWINGS

Further objects and advantages of the invention can be more fully understood from the following detailed description taken in conjunction with the accompanying drawings in which:

FIG. 1 is a perspective view illustrating the structure of a common plasma display panel;

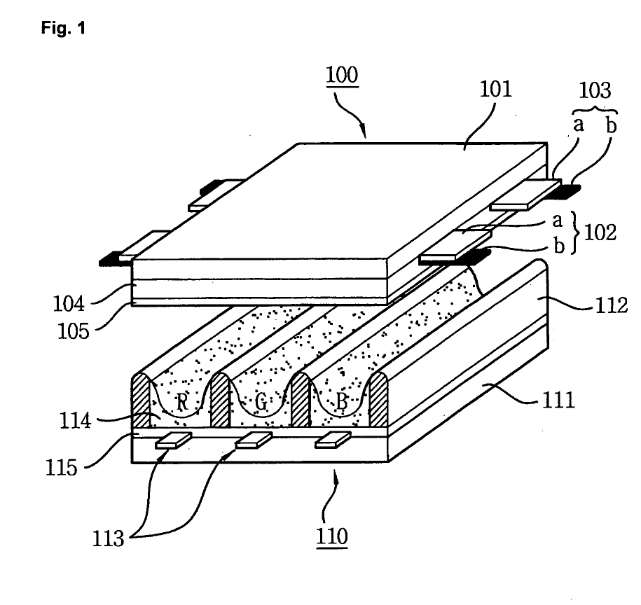

FIG. 2 is a view for explaining a method of implementing an image of a conventional plasma display apparatus;

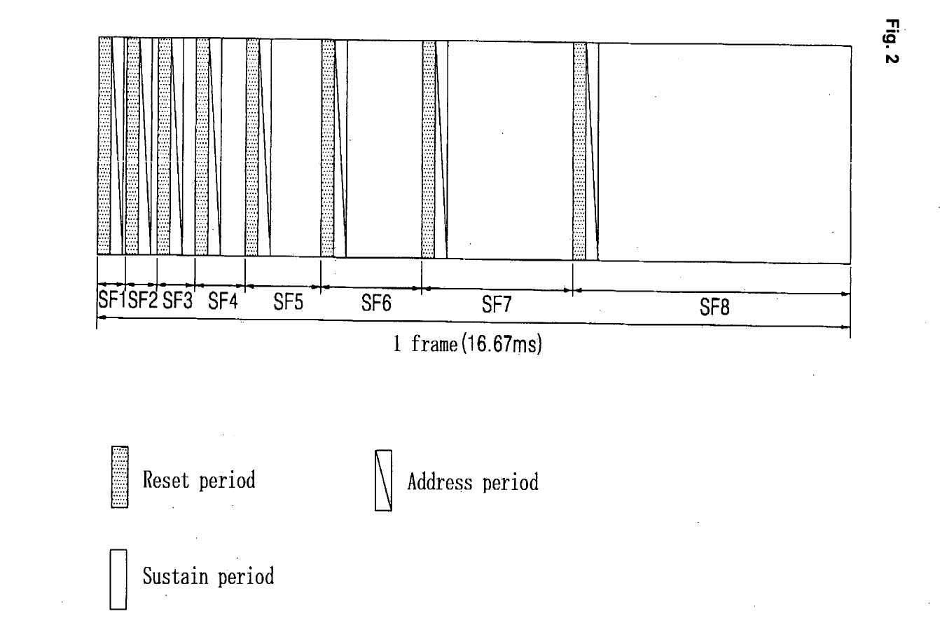

FIG. 3 is a schematic block diagram of a conventional plasma display apparatus;

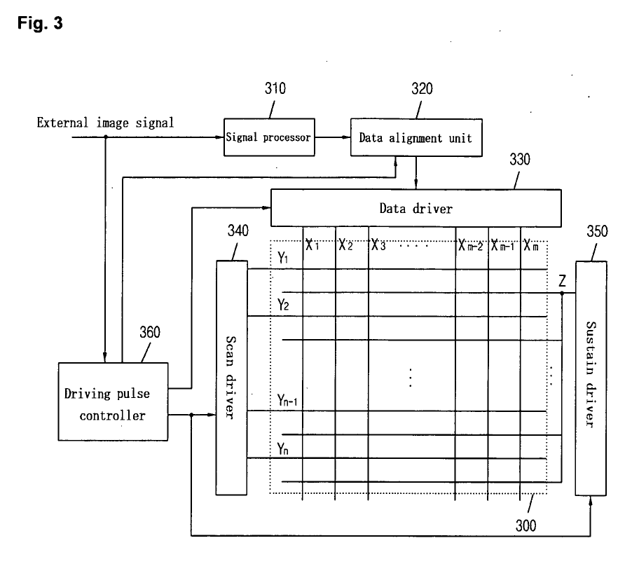

FIG. 4 is a circuit diagram showing a conventional plasma display apparatus;

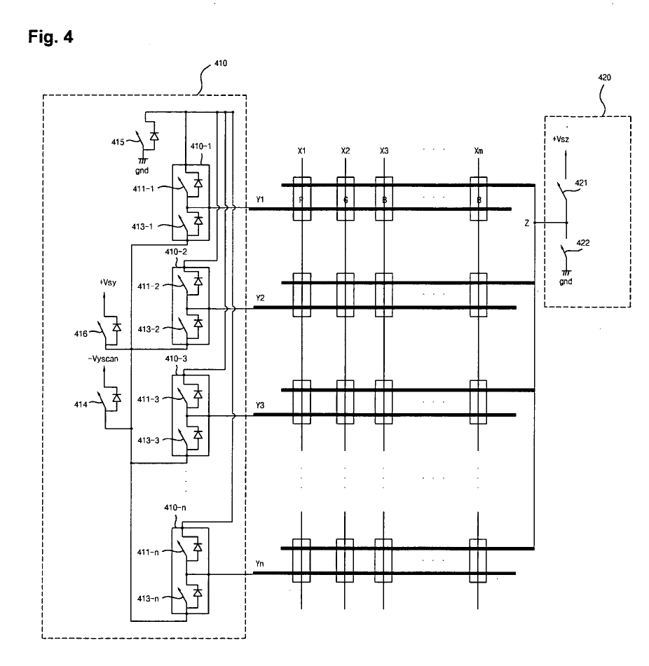

FIG. 5 is a block diagram showing the construction of a plasma display apparatus according to a first embodiment of the present invention;

FIG. 6 is a circuit diagram showing the plasma display apparatus according to a first embodiment of the present invention;

FIG. 7 is a switching timing diagram for explaining the operation of the plasma display apparatus according to a first embodiment of the present invention;

FIG. 8 is a view showing a driving waveform of the plasma display apparatus according to a first embodiment of the present invention;

FIG. 9 is a block diagram showing the construction of a plasma display apparatus according to a second embodiment of the present invention;

FIG. 10 is a circuit diagram of the plasma display apparatus according to a second embodiment of the present invention; and

FIG. 11 is a switching timing diagram for explaining the operation of the plasma display apparatus according to a second embodiment of the present invention.

### DETAILED DESCRIPTION OF THE PREFERRED EMBODIMENT

The present invention will now be described in detail in connection with preferred embodiments with reference to the accompanying drawings.

### First Embodiment

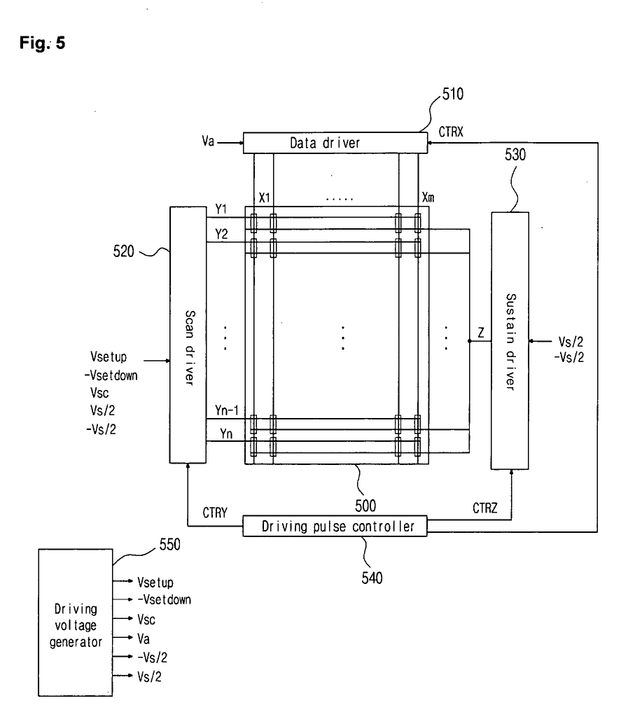

FIG. 5 is a block diagram showing the construction of a plasma display apparatus according to a first embodiment of the present invention.

As shown in FIG. 5, the plasma display apparatus according to a first embodiment of the present invention includes a plasma display panel 500, a data driver 510, a scan driver 520, a sustain driver 530, a driving pulse controller 540 and a driving voltage generator 550.

In the plasma display panel 500 are formed scan electrodes Y₁ to Yn and a sustain electrode Z, and a plurality of address electrodes X₁ to Xm crossing the scan electrodes Y₁ to Yn and the sustain electrode Z.

The data driver 510 applies data to the address electrodes X₁ to Xm formed in the plasma display panel 500. In this case, the data are image signal data that are processed in an image signal processor (not shown) for processing an externally input image signal. The data driver 510 samples and latches data in response to a data timing control signal CTRX from the driving pulse controller 540 and supplies address pulses having an address voltage Va to the respective address electrodes X₁ to Xm.

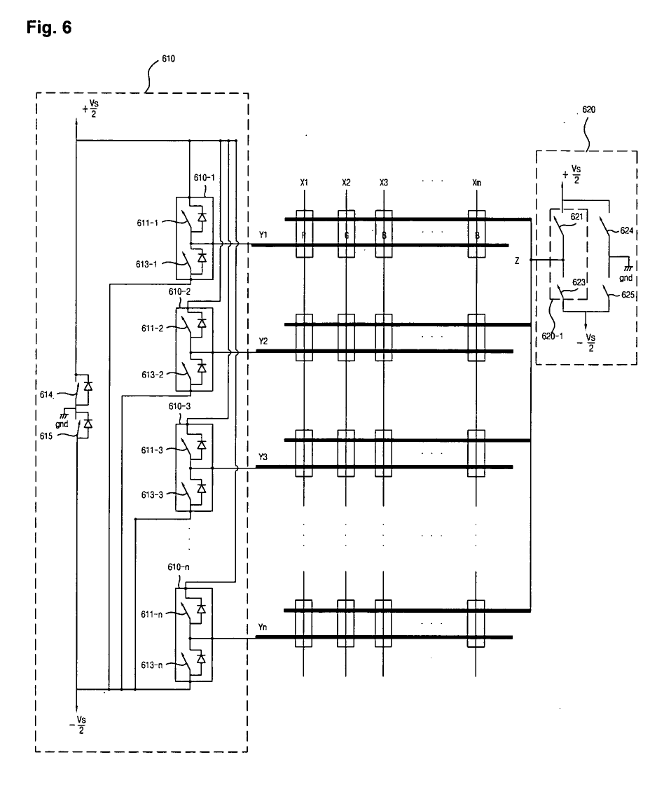

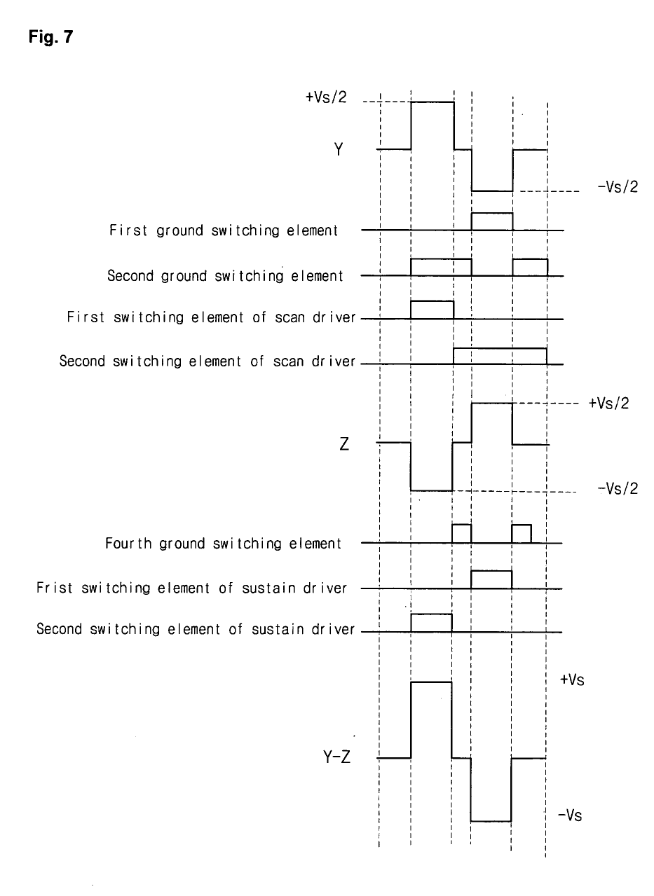

The scan driver 520 drives the scan electrodes Y₁ to Yn formed in the plasma display panel 500. The scan driver 520 first supplies a set-up pulse, which constitutes a ramp waveform and rises up to a set-up voltage (Vsetup) level, and a set-down pulse falling down to a set-down voltage −Vsetdown to the scan electrodes Y₁ to Yn during the reset period under the control of the driving pulse controller 540. Thereafter, during the address period, the scan driver 520 sequentially applies a scan pulse of a negative polarity, which falls from a scan reference voltage Vsc, to the scan electrodes Y1 to Yn, respectively. At this time, the scan waveform and the sustain waveform of the negative polarity according to a first embodiment of the present invention employ the same voltage −Vs/2 supplied from the driving voltage generator 550. This will be described in detail with reference to FIGS. 6 and 7. Thereafter, the scan driver 520 supplies at least one or more sustain pulses, and a sustain pulse of a negative polarity having the same amount as that of the scan pulse of the positive polarity to the scan electrodes Y1 to Yn during the sustain period for the purpose of a sustain discharge.

The sustain driver 530 drives the sustain electrode Z, which serves as a common electrode and is formed in the plasma display panel 500. The sustain driver 530 supplies a reference pulse of a ground (GND) voltage level to the sustain electrodes Z during the address period, and also supplies sustain pulses having an opposite polarity to a sustain pulse of a positive polarity and a sustain pulse of a negative polarity, which are supplied to the scan electrodes Y1 to Yn, to the sustain electrodes Z during the sustain period, under the control of the driving pulse controller 540.

The driving pulse controller 540 controls the data driver 510, the scan driver 520 and the sustain driver 530 when the plasma display panel 500 is driven. That is, the driving pulse controller 540 generates operating timings of the data driver 510, the scan driver 520 and the sustain driver 530 and timing control signals CTRX, CTRY and CTRZ for controlling synchronization during the reset period, the address period and the sustain period. The driving pulse controller 540 also transmits the timing control signals CTRX, CTRY and CTRZ to the driving units 510, 520 and 530, respectively.

At this time, the data control signal CTRX includes a sampling clock for sampling data, a latch control signal, and a switching control signal for controlling on/off time of an energy recovery circuit and a driving switching element within the data driver 510. The scan control signal CTRY includes a switching control signal for controlling on/off time of an energy recovery circuit and a driving switching element within the scan driver 520. The sustain control signal CTRZ includes a switching control signal for controlling on/off time of an energy recovery circuit and a driving switching element within the sustain driver 530.

The driving voltage generator 550 generates driving voltages necessary for the driving pulse controller 540 and the respective driving units 510, 520 and 530, and supplies them thereto. That is, the driving voltage generator 550 generates a set-up voltage Vsetup, the set-down voltage Vsetdown, the scan reference voltage Vsc, the sustain voltage of the positive polarity −Vs/2, the sustain voltage of the negative polarity Vs/2, and the address voltage Va. These driving voltages can be controlled according to the composition of a discharge gas or the structure of a discharge cell.

As such, in the plasma display apparatus according to a first embodiment of the present invention, the low driving voltages generated in the driving voltage generator 550 are supplied to the plasma display panel 500 through the driving unit 510, 520 and 530 under the control of the driving pulse controller 540. Furthermore, in the first embodiment of the present invention, the structure of the circuits of the plasma display apparatus can be simplified by controlling a scan waveform to have the same voltage as that of the sustain waveform of the negative polarity during the address period. In this case, the construction of the circuits of the plasma display apparatus according to a first embodiment of the present invention and an operating characteristic thereof will be described with reference to FIGS. 6 and 7.

FIG. 6 is a circuit diagram showing the plasma display apparatus according to a first embodiment of the present invention. FIG. 7 is a switching timing diagram for explaining the operation of the plasma display apparatus according to a first embodiment of the present invention.

As shown in FIG. 6, the plasma display apparatus according to a first embodiment of the present invention includes a plasma display panel 600, a scan driving unit 610 and a common driving unit 620.

In the plasma display panel 600 are formed scan electrodes Y1 to Yn and a sustain electrode Z, and a plurality of address electrodes X1 to Xm crossing the scan electrodes Y₁ to Yn and the sustain electrode Z.

The scan driving unit 610 includes a plurality of scan drivers 610-1 to 610-n that provide the waveforms applied to the scan electrodes Y₁ to Yn. The scan drivers 610-1 to 610-n include first switching elements 611-1 to 611-n that supply a scan reference pulse during an address period and a sustain pulse of a positive polarity during a sustain period, and second switching elements 613-1 to 613-n that supply a scan pulse during the address period and a sustain pulse of a negative polarity during the sustain period. Furthermore, the scan driving unit 610 includes a first ground switching element 614 and a second ground switching element 615 for maintaining the scan electrodes Y₁ to Yn to a ground voltage (GND) level in a predetermined period.

The common driving unit 620 includes a common driver 620-1 that supplies the waveforms applied to the sustain electrode Z serving as the common electrode. The common driver 620-1 includes a first switching element 621 that supplies a sustain pulse of a positive polarity during the sustain period, and a second switching element 623 that supplies a sustain pulse of a negative polarity during the sustain period. The common driving unit 620 further includes a third ground switching element 624 and a fourth ground switching element 625 for maintaining the sustain electrode Z to the ground voltage (GND) level in a predetermined period.

In the plasma display apparatus according to a first embodiment of the present invention, during the address period, the first ground switching element 614 is turned on and the first switching elements 611-1 to 611-n of the scan drivers 610-1 to 610-n are turned on, so that the scan reference pulse of the ground voltage (GND) level is applied to the scan electrodes Y1 to Yn. That is, since a voltage level of the scan reference waveform is kept to the ground voltage (GND), there is no need for an additional voltage source.

At this time, the second switching element (one of 613-1 to 613-n) of the scan driver (one of 610-1 to 610-n) that is responsible for one selected scan electrode is turned on, and the second switching element of the scan driver that is responsible for the remaining non-selected scan electrodes is turned off.

For example, if a first scan electrode Y1 is selected, the second switching element 613-1 of the scan driver 610-1 that is responsible for the first scan electrode Y1 is turned on, and the second switching elements 613-2 to 613-n of the remaining scan drivers 610-2 to 610-n are turned off. Accordingly, address pulses are applied to all the address electrodes X1 to Xm simultaneously when a scan pulse of a voltage of a negative polarity −Vs/2 is applied to the first scan electrode Y1. Thus, an address discharge process is performed on a cell on the first scan electrode Y1 due to a voltage difference between the scan pulse of the negative polarity and the address pulse.

As such, in the plasma display apparatus according to a first embodiment of the present invention, the scan waveforms applied to the scan electrodes Y1 to Yn during the address period, and the sustain waveforms of the negative polarity, which are applied to the scan electrodes Y1 to Yn and the sustain electrode Z during the sustain period, have the same voltage. In this case, the voltage is Vs/2 lower than the conventional sustain voltage Vs.

A sustain process will be described below in connection with the switching timing diagram of FIG. 7.

First, the first switching elements 611-1 to 611-n of the scan drivers 610-1 to 610-n, the second ground switching element 615, and the second switching element 1023 of the common driver 620-1 are turned on. Accordingly, a sustain pulse of a positive polarity of the positive-polarity voltage Vs/2 is applied to all the scan electrodes Y1 to Yn, and a sustain pulse of a negative polarity of the negative-polarity voltage −Vs/2 is applied to all the sustain electrodes Z. A voltage difference between the scan electrodes and the sustain electrode becomes the sustain discharge voltage Vs as shown in FIG. 7, so that the sustain discharge is performed.

Thereafter, the second ground switching element 615 keeps turned on, and the second switching elements 613-1 to 613-n of the scan drivers 610-1 to 610-n and the fourth ground switching element 1025 are turned on. Accordingly, all the scan electrodes Y1 to Yn and the sustain electrode Z become the ground voltage (GND) level. That is, in the first embodiment of the present invention, when the polarity of sustain waveforms applied to one or more of the scan electrodes or the sustain electrode changes, a predetermined sustain reference waveform is applied. This is for securing sufficient driving margin considering switch timing when the polarity of the sustain waveform changes. Preferably, the sustain reference waveform maintains the ground voltage level so that the plasma display apparatus can drive in a more stable manner.

Thereafter, the first ground switching element 614 and the first switching element 1021 of the common driver 620-1 are turned on, and the second switching elements 613-1 to 613-n of the scan drivers 610-1 to 610-n keep turned on. Accordingly, a sustain pulse of a negative polarity of the negative-polarity voltage −Vs/2 is applied to all the scan electrodes Y1 to Yn, and a sustain pulse of a positive polarity of the positive-polarity voltage Vs/2 is applied to all the sustain electrodes Z. Therefore, a, voltage difference between the scan electrodes and the sustain electrodes becomes the sustain discharge voltage Vs, as shown in FIG. 7, so that a sustain discharge occurs.

Thereafter, the second ground switching element 330 and the fourth ground switching element 370 are turned on, and a second switching element for Y electrode keeps turned on. Accordingly, all the Y electrodes Y1 to Yn and the Z electrodes Z1 to Zn become the ground level.

As such, in the plasma display apparatus according to a first embodiment of the present invention, the scan process and the sustain process are performed using a voltage source of a positive polarity and a voltage source of a negative polarity, which correspond to ½ times of the conventional sustain voltage.

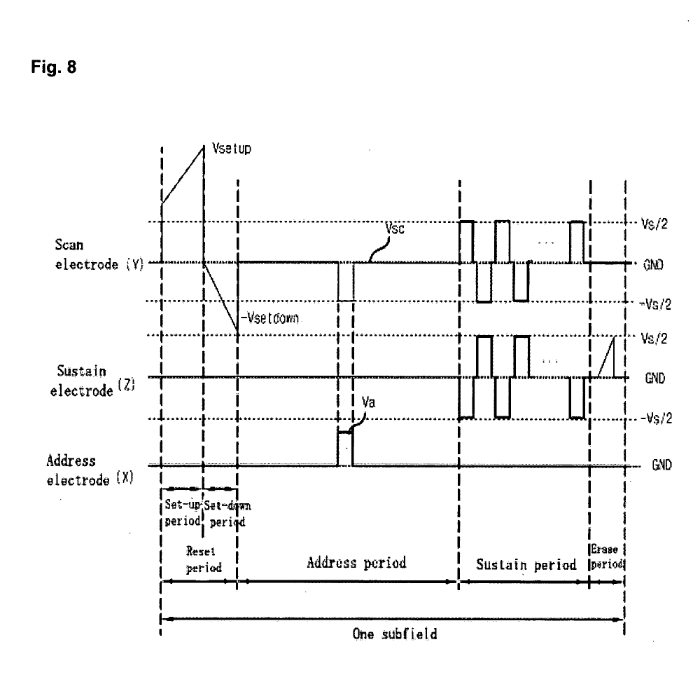

FIG. 8 is a view showing the driving waveform of the plasma display apparatus according to a first embodiment of the present invention.

As shown in FIG. 8, in the plasma display apparatus according to a first embodiment of the present invention, one sub-field is driven with it being divided into a reset period for initializing the entire cells, an address period for selecting cells to be discharged, a sustain period for maintaining discharging of selected cells, and an erase period for erasing wall charges within discharged cells.

In a set-up period of the reset period, a ramp-up waveform Ramp-up is applied to all the scan electrodes at the same time. A weak dark discharge is generated within discharge cells of the entire screen by means of the ramp-up waveform. The set-up discharge causes wall charges of the positive polarity to be accumulated on the address electrodes and the sustain electrodes, and wall charges of the negative polarity to be caused on the scan electrodes.

In a set-down period, as a set-down pulse of a ramp-down waveform, which gradually falls from a ground (GND) voltage level, is applied, an erase discharge is generated, sufficiently easing wall charges formed within cells. The set-down discharge causes wall charges to remain within the cells to the extent that an address discharge can occur stably.

In the address period, simultaneously when scan pulses of a negative polarity, which falls from the scan reference pulse of the ground voltage level, are sequentially applied to the scan electrodes, address pulses of a positive polarity are applied to the address electrodes in synchronization with the scan pulses. As a voltage difference between the scan pulses and the address pulses and a wall voltage generated in the reset period are added, an address discharge is generated within discharge cells to which the address pulses are applied. Wall charges are formed within cells selected by the address discharge to the extent that a discharge can occur when a sustain voltage of a negative polarity −Vs is applied.

In this case, in the first embodiment of the present invention, the scan waveform applied to the scan electrodes in the address period have the same voltage as that of the sustain waveform of the negative polarity. This obviates the need for an additional voltage source. Furthermore, as described above, since a voltage level is lowered, consumption power can be saved efficiently. Furthermore, the reference waveform of the ground voltage (GND) level is applied to the sustain electrode according to a first embodiment of the present invention during the address period. Therefore, since a voltage difference between the sustain electrode and the scan electrodes reduces, an erroneous discharge can be prevented from occurring between the sustain electrode and the scan electrodes.

In the sustain period, while a sustain waveform of a positive polarity is applied to one of the scan electrodes and the sustain electrode, a sustain waveform of a negative polarity is applied to the other of the scan electrodes and the sustain electrode, thus forming a voltage difference corresponding to a sustain discharge voltage. That is, in cells selected by an address discharge, a sustain discharge, i.e., a display discharge is generated between the scan electrodes and the sustain electrode by means of a wall voltage within the cells and every sustain pulse. Therefore, as described above, the cells can be driven with low-voltage driving.

In this case, in the first embodiment of the present invention, the sustain waveform of the positive polarity and the sustain waveform of the negative polarity have the same voltage of Vs/2. This can simplify the construction of hardware, and switching elements having the same voltage-resistant property can be used. However, the sustain waveform of the positive polarity and the sustain waveform of the negative polarity can have different amounts of voltages, if needed. That is, by allowing the sustain waveform of the negative polarity to have a higher voltage, the voltage level of the scan waveform applied with the same voltage level can be lowered. The voltage level of the address waveform applied to the address electrodes can also be lowered. To the contrary, by allowing the sustain waveform of the positive polarity to have a higher voltage, if the voltage level of the sustain waveform of the positive polarity is raised considering the voltage level of the set-up waveform, the voltage level of the set-up waveform can be lowered. This will be described in detail through characteristics according to a second embodiment of the present invention.

In the erase period, a voltage of an erase ramp (Ramp-ers) waveform having a small pulse width and a low voltage level is applied to the sustain electrode, thus erasing wall charges remaining within cells of the entire screen.

As such, the plasma display apparatus according to the first embodiment of the present invention is advantageous in terms of driving and efficiency since a low driving voltage compared to the prior art is used, and has low power consumption since invalid power decreases. Furthermore, since a low driving voltage is used, the production cost can be saved. Moreover, the plasma display apparatus according to the first embodiment of the present invention can simplify circuits and can be advantageous in driving since a scan process and a sustain process are carried out using the same voltage source.

### Second Embodiment

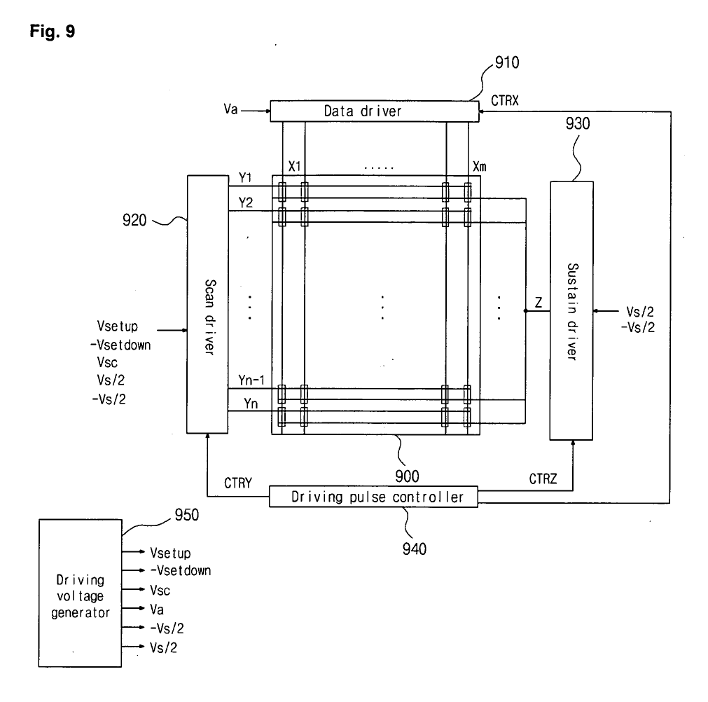

FIG. 9 is a block diagram showing the construction of a plasma display apparatus according to a second embodiment of the present invention.

As shown in FIG. 9, the plasma display apparatus according to a second embodiment of the present invention includes a plasma display panel 900, a data driver 910, a scan driver 920, a sustain driver 930, a driving pulse controller 940 and a driving voltage generator 950.

In the plasma display panel 900 are formed scan electrodes Y₁ to Yn and a sustain electrode Z, and a plurality of address electrodes X₁ to Xm crossing the scan electrodes Y₁ to Yn and the sustain electrode Z.

The data driver 910 applies-data to the address electrodes X₁ to Xm formed on the plasma display panel 900. In this case, the data are image signal data that are processed in an image signal processor (not shown) for processing an externally input image signal. The data driver 910 samples and latches data in response to a data timing control signal CTRX from the driving pulse controller 940 and supplies address pulses having an address voltage Va to the respective address electrodes X₁ to Xm.

The scan driver 920 drives the scan electrodes Y₁ to Yn formed on the plasma display panel 900. The scan driver 920 first supplies a set-up pulse, which constitutes a ramp waveform and rises up to a set-up voltage (Vsetup) level, and a set-down pulse falling down to a set-down voltage −Vsetdown to the scan electrodes Y₁ to Yn during the reset period under the control of the driving pulse controller 940. Thereafter, during the address period, the scan driver 920 sequentially applies a scan pulse of a negative polarity, which falls from a scan reference voltage Vsc, to the scan electrodes Y1 to Yn, respectively. The scan waveform and the sustain waveform of the negative polarity have the same voltage −Vs/2 supplied from the driving voltage generator 950.

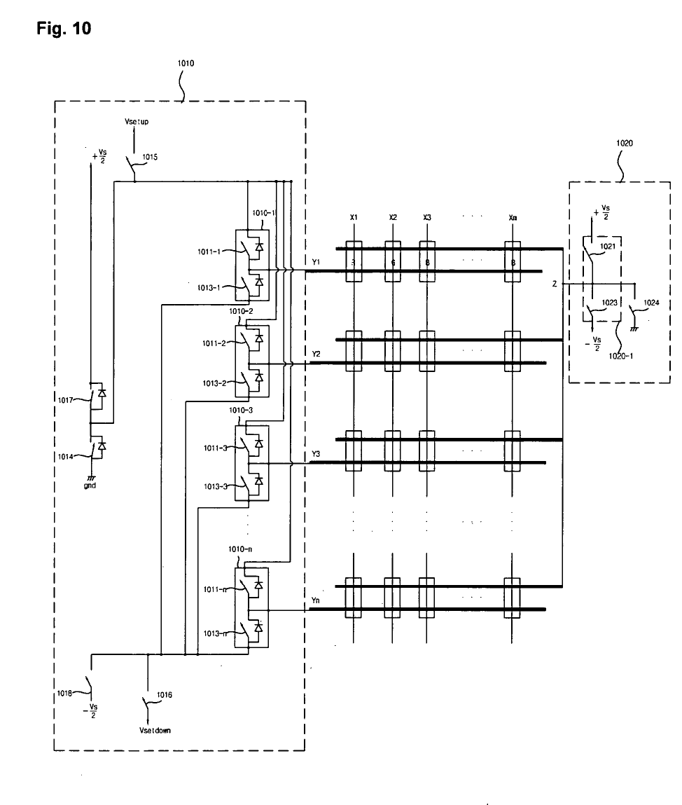

The set-up pulse supplied from the scan driver 920 according to the second embodiment of the present invention forms a ramp-up waveform that gradually rises after a waveform of a positive polarity of the same voltage (V/2) level as that of a sustain waveform of a positive polarity is applied. Furthermore, the set-down waveform constitutes a ramp-down waveform that gradually falls in an opposite polarity to the set-up waveform. At this time, the sustain driver 930 supplies pulses of waveforms having an opposite polarity to the set-up waveform and waveforms having an opposite polarity to the set-down waveform. It is thus possible to reduce the amount of voltages of the set-up pulse and the set-down pulse. This will be described in detail with reference to FIG. 10.

Thereafter, the scan driver 920 supplies at least one or more sustain pulses, and a sustain pulse of a negative polarity having the same amount as that of the scan pulse of the positive polarity to the scan electrodes Y1 to Yn during the sustain period for the purpose of a sustain discharge.

The sustain driver 930 drives the sustain electrode Z, which serves as a common electrode and is formed in the plasma display panel 900. The sustain driver 930 supplies a reference pulse of a ground (GND) voltage level to the sustain electrodes Z during the address period, and also supplies sustain pulses of an opposite polarity to the sustain pulse of the positive polarity and the negative-polarity sustain pulse, which are supplied to the scan electrodes Y1 to Yn, to the sustain electrodes Z during the sustain period, under the control of the driving pulse controller 940.

The driving pulse controller 940 controls the data driver 910, the scan driver 920 and the sustain driver 930 when the plasma display panel 900 is driven. That is, the driving pulse controller 940 generates operating timings of the data driver 910, the scan driver 920 and the sustain driver 930 and timing control signals CTRX, CTRY and CTRZ for controlling synchronization during the reset period, the address period and the sustain period. The driving pulse controller 940 also transmits the timing control signals CTRX, CTRY and CTRZ to the driving units 910, 920 and 930, respectively.

At this time, the data control signal CTRX includes a sampling clock for sampling data, a latch control signal, and a switching control signal for controlling on/off time of an energy recovery circuit and a driving switching element within the data driver 910. The scan control signal CTRY includes a switching control signal for controlling on/off time of an energy recovery circuit and a driving switching element within the scan driver 920. The sustain control signal CTRZ includes a switching control signal for controlling on/off time of an energy recovery circuit and a driving switching element within the sustain driver 930.

The driving voltage generator 950 generates driving voltages necessary for the driving pulse controller 940 and the respective driving units 910, 920 and 930, and supplies them thereto. That is, the driving voltage generator 950 generates a set-up voltage Vsetup, the set-down voltage Vsetdown, the scan reference voltage Vsc, the sustain voltage of the positive polarity −Vs/2, the sustain voltage of the negative polarity Vs/2, and the address voltage Va. These driving voltages can be controlled according to the composition of a discharge gas or the structure of a discharge cell.

As such, in the plasma display apparatus according to the second embodiment of the present invention, the low driving voltages generated in the driving voltage generator 950 are supplied to the plasma display panel 900 through the driving unit 910, 920 and 930 under the control of the driving pulse controller 940. More particularly, in the second embodiment of the present invention, since a pulse having an opposite polarity to the set-up pulse applied to the scan electrodes is applied to the sustain electrode during the reset period, low-voltage driving is possible. In this case, the construction of the circuits of the plasma display apparatus according to the second embodiment of the present invention and an operating characteristic thereof will be described with reference to FIG. 10.

FIG. 10 is a circuit diagram of the plasma display apparatus according to the second embodiment of the present invention.

As shown in FIG. 10, the plasma display apparatus according to a second embodiment of the present invention includes a plasma display panel 1000, a scan driver 1010 and a sustain driver 1020.

In the plasma display panel 1000 are formed scan electrodes Y₁ to Yn and a sustain electrode Z, and a plurality of address electrodes X₁ to Xm crossing the scan electrodes Y₁ to Yn and the sustain electrode Z.

The scan driver 1010 includes a plurality of scan drivers 1010-1 to 1010-n that provide the waveforms applied to the scan electrodes Y₁ to Yn. The scan drivers 1010-1 to 1010-n include first switching elements 1011-1 to 1011-n that supply a set-up pulse during the set-up period, a scan reference pulse during the address period and a sustain pulse of a positive polarity during the sustain period, and second switching elements 1013-1 to 1013-n that supply a set-down pulse during the set-down period, a scan pulse during the address period and a sustain pulse of a negative polarity during the sustain period.

Furthermore, the scan driver 1010 includes a first ground switching element 614 for maintaining the scan electrodes Y₁ to Yn to a ground voltage (GND) level in a predetermined period.

The scan driver 1010 further a switching element 1015 for a set-up voltage, which supplies the set-up voltage Vsetup generated in the driving voltage generator, a switching element 1016 for a set-down voltage, which supplies the set-down voltage Vsetdown, a switching element 1017 for a sustain voltage of a positive polarity, which supplies the sustain voltage of the positive polarity Vs/2, and a switching element 1018 for a sustain voltage of a negative polarity, which supplies the sustain voltage of the negative polarity −Vs/2.

The sustain driver 1020 includes a sustain driver 1020-1 that supplies the waveforms applied to the sustain electrode Z serving as the common electrode. The sustain driver 1020-1 includes a first switching element 1021 that supplies a pulse having an opposite pulse to the set-down waveform during a set-down period and a sustain pulse of a positive polarity during a sustain period, and a second switching element 1023 that supplies a pulse having an opposite polarity to the set-up waveform during a set-up period and a sustain pulse of a negative polarity during the sustain period. The sustain driver 1020 further includes a third ground switching element 1024 and a fourth ground switching element 1025 for maintaining the sustain electrode Z to the ground voltage (GND) level in a predetermined period.

In the plasma display apparatus according to the second embodiment of the present invention, during a reset period, the switching element 1017 for the sustain voltage of the positive polarity, the first switching elements 1011-1 to 1011-n of the scan drivers 1010-1 to 1010-n, and the second switching element 1023 of the sustain driver 1020-1 are turned on. Accordingly, a voltage difference between the scan electrodes Y₁ to Yn and the sustain electrode Z becomes a sustain discharge voltage Vs. At this time, the switching element 1015 for the set-up voltage is turned on, so that a set-up pulse of a ramp waveform that gradually rises is applied.

That is, the last voltage of all the scan electrodes Y1 to Yn results in the sum of the sustain voltage Vs and the set-up voltage Vsetup. As such, in the second embodiment of the present invention, since a pulse having an opposite polarity to the set-up waveform is applied to a sustain electrode during a set-up period, low-voltage driving is possible in the same manner as the prior art. At this time, a waveform having an opposite polarity is applied with the same voltage (−Vs/2) level as a sustain waveform of a negative polarity. This can simplify hardware construction and can save the production cost.

The switching element 1015 for the set-up voltage is then turned off.

Thereafter, the switching element 1017 for the sustain voltage of the positive polarity, the first switching elements 1011-1 to 1011-n of the scan drivers 1010-1 to 1010-n, and the second switching element 1023 of the sustain driver 1020-1 are turned off. The first switching element 1021 of the sustain driver 1020-1 and the switching element 1016 for the set-down voltage are also turned on. Accordingly, a voltage level of the scan electrodes Y1 to Yn falls from the positive polarity of the sustain voltage Vs/2 to the last voltage (−Vsetdown) level of the set-down pulse. Furthermore, the sustain electrode Z is applied with a waveform of a negative polarity of a set-down pulse having the sustain voltage of the positive polarity (Vs/2) level during a set-down period.

Thereafter, the operating characteristic of the address period and the sustain period according to the second embodiment of the present invention is the same as those of the plasma display apparatus according to the first embodiment of the present invention, which has been described with reference to FIGS. 6 and 7. Detailed description thereof will be thus omitted.

As such, in the plasma display apparatus according to the second embodiment of the present invention, a reset process as well as a scan process and a sustain process are performed using a voltage source of a positive polarity and a voltage source of a negative polarity, which correspond to ½ times of the conventional sustain voltage.

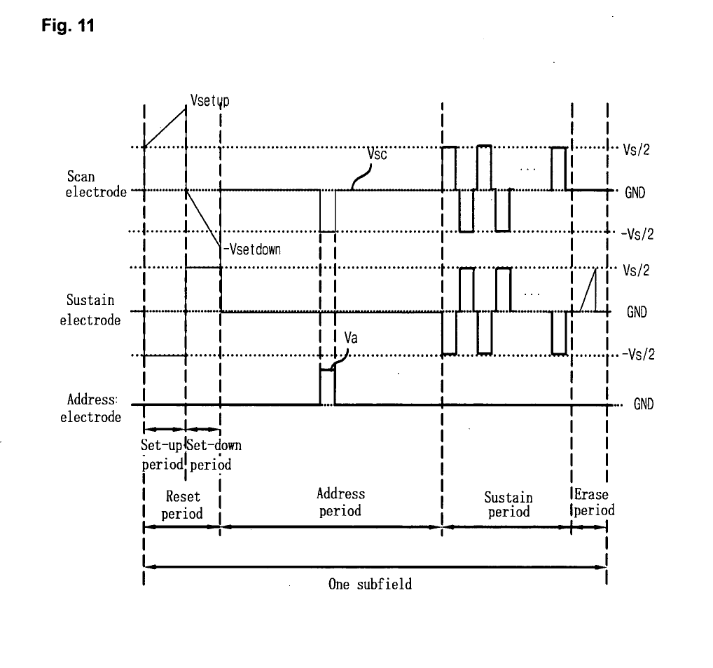

FIG. 11 is a view showing the driving waveform of the plasma display apparatus according to a second embodiment of the present invention.

As shown in FIG. 11, in the plasma display apparatus according to the second embodiment of the present invention, one sub-field is driven with it being divided into a reset period for initializing the entire cells, an address period for selecting cells to be discharged, a sustain period for maintaining discharging of selected cells, and an erase period for erasing wall charges within discharged cells.

In a set-up period of the reset period, a ramp-up waveform Ramp-up is applied to all the scan electrodes at the same time. A weak dark discharge is generated within discharge cells of the entire screen by means of the ramp-up waveform. The set-up discharge causes wall charges of the positive polarity to be accumulated on the address electrodes and the sustain electrodes, and wall charges of the negative polarity to be caused on the scan electrodes.

At this time, the set-up waveform applied to the scan electrodes according to the second embodiment of the present invention constitutes a ramp-up waveform that gradually rises from the same voltage (Vs/2) level as the sustain waveform of the positive polarity. At the same time, a waveform having an opposite polarity to the set-up waveform applied to the sustain electrode constitutes the same voltage (−Vs/2) level as the sustain waveform of the negative polarity. Accordingly, the same voltage difference as that of the prior art can be secured, and low-voltage driving is possible.

In the set-down period, as a set-down pulse of a ramp-down waveform that gradually falls from the same voltage level as the sustain voltage of the positive polarity Vs/2 is applied, an erase discharge is generated. Wall charges formed within cells are sufficiently erased. Further, wall charges uniformly remain to the extent that an address discharge can occur stably by means of a set-down discharge. At this time, a reference waveform, which has an opposite polarity and the same voltage (Vs/2) level as that of a sustain waveform of a positive polarity of a set-down waveform is applied to the sustain electrode, an excessive erase discharge between the scan electrodes and the sustain electrode can be prevented.

Thereafter, characteristics of a driving waveform during an address period, a sustain period and an erase period according to the second embodiment of the present invention are the same as those of the driving waveform according to the first embodiment of the present invention, which have been described with reference to FIG. 8. Detailed description thereof will be thus omitted.

In the second embodiment of the present invention, when a set-up pulse is applied, a reset process, a scan process and a sustain process can be performed at the same time using the sustain voltage source of the positive polarity +Vs/2 and the sustain voltage source of the negative polarity −Vs/2 without an additional sustain voltage source. Accordingly, there are effects in that power consumption can be saved, efficiency can be increased, and the load of a high voltage to a driving circuit can be curtained since a low voltage is used.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display apparatus comprising:
a plasma display panel in which a plurality of sustain electrodes including scan electrodes and sustain electrodes are formed;
a driving unit for driving the plurality of the sustain electrodes; and
a driving pulse controller for controlling the driving unit to apply simultaneously a sustain waveform having different polarity to the sustain electrodes respectively for sustaining the display of discharge cells.

2. The plasma display apparatus as claimed in claim 1, wherein a scan waveform synchronized with an address waveform which is applied to address electrode during address period is applied to the scan electrode.

3. The plasma display apparatus as claimed in claim 1, wherein the driving pulse controller controls the voltage difference of the simultaneously applied sustain waveform having different polarity to be Vs.

4. The plasma display apparatus as claimed in claim 1, wherein the sustain waveform is −Vs/2 and +Vs/2 respectively.

5. A plasma display apparatus comprising:
a plasma display panel in which a plurality of sustain electrodes having scan electrodes and sustain electrodes are formed;
a driving unit for driving the plurality of the sustain electrodes; and
a driving pulse controller includes a voltage source having different polarity, sustaining the display of discharge cells by simultaneously applying a sustain waveform having different polarity to the sustain electrodes respectively.

6. The plasma display apparatus as claimed in claim 5, wherein a scan waveform synchronized with an address waveform which is applied to address electrode during address period is applied to the scan electrode.

7. The plasma display apparatus as claimed in claim 5, wherein the driving pulse controller controls the voltage difference of the simultaneously applied sustain waveform having different polarity to be Vs.

8. The plasma display apparatus as claimed in claim 7, wherein the sustain waveform is −Vs/2 and +Vs/2 respectively.

9. A plasma display apparatus, comprising:
a plasma display panel in which a plurality of sustain electrodes having scan electrodes and common electrodes are formed;
a driving unit for driving the plurality of the sustain electrodes; and
a driving pulse controller for controlling the driving unit to apply a scan waveform of a negative polarity to the scan electrodes during an address period, and a sustain waveform of a positive polarity and a sustain waveform of a negative polarity, which has the same voltage as that of the scan waveform, to the scan electrodes during a sustain period, and to apply sustain waveforms having an opposite polarity to the sustain waveform of the positive polarity and the sustain waveform of the negative polarity, which are applied to the scan electrodes, to the common electrodes during the sustain period.

10. The plasma display apparatus as claimed in claim 9, wherein the driving unit for driving the sustain electrodes includes:
a scan driver including a first switching element and a second switching element for supplying the waveforms to the scan electrodes; and
a sustain driver including a first switching element and a second switching element for supplying the waveforms to the sustain electrodes.

11. The plasma display apparatus as claimed in claim 10, wherein the scan driver applies a scan reference waveform and the sustain waveform of the positive polarity through the first switching element, and the scan waveform and the sustain waveform of the negative polarity through the second switching element.

12. The plasma display apparatus as claimed in claim 11, wherein the scan reference waveform is a ground voltage level.

13. The plasma display apparatus as claimed in claim 10, wherein the sustain driver applies the sustain waveform of the positive polarity through the first switching element, and the sustain waveform of the negative polarity through the second switching element.

14. The plasma display apparatus as claimed in claim 9, wherein a voltage difference between the sustain waveform of the positive polarity and the sustain waveform of the negative polarity becomes the amount of a sustain discharge voltage.

15. The plasma display apparatus as claimed in claim 9, wherein the sustain waveform of the positive polarity and the sustain waveform of the negative polarity have the same voltage.

16. The plasma display apparatus as claimed in claim 9, wherein the sustain waveform of the positive polarity and the sustain waveform of the negative polarity have different voltages.

17. The plasma display apparatus as claimed in claim 16, wherein the sustain waveform of the negative polarity has a voltage higher than that of the sustain waveform of the positive polarity.

18. The plasma display apparatus as claimed in claim 16, wherein the sustain waveform of the positive polarity has a voltage higher than that of the sustain waveform of the negative polarity.

19. The plasma display apparatus as claimed in claim 9, wherein when the polarity of the sustain waveform applied to one or more of the scan electrodes or the common electrodes changes, a predetermined sustain reference waveform is applied.

20. The plasma display apparatus as claimed in claim 9, wherein the sustain reference waveform is a ground voltage level.

21. The plasma display apparatus as claimed in claim 20, further including at least one or more ground switching elements for maintaining the ground voltage level.

22. A plasma display apparatus, comprising:
a plasma display panel in which a plurality of sustain electrodes having scan electrodes and common electrodes is formed;
a driving unit for driving the plurality of the sustain electrodes; and
a driving pulse controller for controlling the driving unit to apply a set-up waveform to the scan electrodes during a set-up period, a set-down waveform having an opposite polarity to the set-up waveform to the scan electrodes during a set-down period, and a sustain waveform of a positive polarity and a sustain waveform of a negative polarity to the scan electrodes during a sustain period, and to apply a waveform having an opposite polarity to the set-up waveform to the common electrodes during a set-up period, a waveform having an opposite polarity to the set-down waveform to the sustain electrodes during a set-down period, and a sustain waveform having an opposite polarity to the sustain waveform of the positive polarity and the sustain waveform of the negative polarity, which are applied to the scan electrodes, to the sustain electrodes during a sustain period.

23. The plasma display apparatus as claimed in claim 22, wherein the set-up waveform constitutes a ramp-up waveform that gradually rises, after a waveform of a positive polarity having the same voltage level as that of the sustain waveform of the positive polarity is applied, and the set-down waveform constitutes a ramp-down waveform that gradually falls.

24. The plasma display apparatus as claimed in claim 22, wherein the waveform having the opposite polarity to the set-up waveform applied to the common electrodes has the same voltage level as that of the sustain waveform of the negative polarity, and the waveform having the opposite polarity to the set-down waveform applied to the sustain electrodes has the same voltage level as that of the sustain waveform of the positive polarity.

25. The plasma display apparatus as claimed in claim 22, wherein the driving pulse controller controls the driving unit to apply a scan waveform of a negative polarity, which is the same as the sustain waveform of the negative polarity, to the scan electrodes during an address period.

26. The plasma display apparatus as claimed in claim 22, wherein the driving unit includes:
a scan driver including a first switching element and a second switching element for supplying the waveforms to the scan electrodes; and
a common driver including a first switching element and a second switching element for supplying the waveforms to the common electrodes.

27. The plasma display apparatus as claimed in claim 26, wherein the scan driver applies the set-up waveform and the sustain waveform of the positive polarity through the first switching element, and the set-down waveform and the sustain waveform of the negative polarity through the second switching element.

28. The plasma display apparatus as claimed in claim 26, wherein the common driver applies a waveform having an opposite polarity to the set-down waveform and the sustain waveform of the positive polarity through the first switching element, and a waveform having an opposite polarity to the set-up waveform and the sustain waveform of the negative polarity through the second switching element.

29. A driving method of a plasma display apparatus including a plurality of sustain electrodes which form pairs of scan electrodes and sustain electrodes, wherein the plasma display apparatus comprises a sustain period for sustaining the display of a discharge cell by simultaneously applying sustain waveforms having different polarity to the scan electrodes respectively.

30. A driving method of a plasma display apparatus as claimed in claim 29, wherein a scan waveform synchronized with an address waveform which is applied to address electrodes during address period is applied to the scan electrodes.

31. A driving method of a plasma display apparatus as claimed in claim 29, wherein the voltage difference of the simultaneously applied sustain waveform having different polarity is controlled to be Vs.

32. A driving method of a plasma display apparatus as claimed in claim 31, wherein the sustain waveform is −Vs/2 and +Vs/2 respectively.

33. A driving method of a plasma display apparatus as claimed in claim 29, wherein the polarity of the sustain waveform is alternatively changed during sustain period.

34. A method of driving a plasma display apparatus in which a plurality of sustain electrodes having plural pairs of scan electrodes and common electrodes is formed, comprising the steps of:
applying a scan waveform of a negative polarity to the scan electrodes during an address period, and applying a sustain waveform of a positive polarity and a sustain waveform of a negative polarity, which has the same voltage as that of the scan waveform, to the scan electrodes during a sustain period; and
applying sustain waveforms having an opposite polarity to the sustain waveform of the positive polarity and the sustain waveform of the negative polarity, which are applied to the scan electrodes, to the common electrodes during a sustain period.

35. The plasma display apparatus as claimed in claim 34, wherein a scan reference waveform is applied to the scan electrodes during an address period.

36. The plasma display apparatus as claimed in claim 35, wherein the scan reference waveform is a ground voltage level.

37. The method as claimed in claim 34, wherein a voltage difference between the sustain waveform of the positive polarity and the sustain waveform of the negative polarity becomes the amount of a sustain discharge voltage.

38. The method as claimed in claim 34, wherein the sustain waveform of the positive polarity and the sustain waveform of the negative polarity have the same voltage.

39. The method as claimed in claim 34, wherein the sustain waveform of the positive polarity and the sustain waveform of the negative polarity have different voltages.

40. The method as claimed in claim 39, wherein the sustain waveform of the negative polarity has a voltage higher than that of the sustain waveform of the positive polarity.

42. The method as claimed in claim 34, wherein the sustain waveform of the positive polarity has a voltage higher than that of the sustain waveform of the negative polarity.

43. The method as claimed in claim 42, wherein when the polarity of the sustain waveform applied to one or more of the scan electrodes or the common electrodes changes, a predetermined sustain reference waveform is applied.

44. A method of driving a plasma display apparatus in which a plurality of sustain electrodes having plural pairs of scan electrodes and common electrodes is formed, comprising the steps of:
applying a set-up waveform to the scan electrodes during a set-up period, a set-down waveform having an opposite polarity to the set-up waveform to the scan electrodes during a set-down period, and a sustain waveform of a positive polarity and a sustain waveform of a negative polarity to the scan electrodes during a sustain period; and
applying a waveform having an opposite polarity to the set-up waveform to the sustain electrodes during a set-up period, a waveform having an opposite polarity to the set-down waveform to the sustain electrodes during a set-down period, and a sustain waveform having an opposite polarity to the sustain waveform of the positive polarity and the sustain waveform of the negative polarity, which are applied to the scan electrodes, to the common electrodes during a sustain period.

45. The method as claimed in claim 44, wherein the set-up waveform constitutes a ramp-up waveform that gradually rises, after a waveform of a positive polarity having the same voltage level as that of the sustain waveform of the positive polarity is applied, and the set-down waveform constitutes a ramp-down waveform that gradually falls.

46. The method as claimed in claim 44, wherein the waveform having the opposite polarity to the set-up waveform applied to the common electrodes has the same voltage level as that of the sustain waveform of the negative polarity, and the waveform having the opposite polarity to the set-down waveform applied to the sustain electrodes has the same voltage level as that of the sustain waveform of the positive polarity.

47. The method as claimed in claim 44, wherein a scan waveform of a negative polarity, which is the same as the sustain waveform of the negative polarity, is applied to the scan electrodes during an address period.
